(19) United States
(12) Patent Application Publication
(10) Pub. No.: US 2017/0328473 A1
(43) Pub. Date: Nov. 16, 2017

(54) PACKING MEMBER FOR WATER-TIGHTENING PIPE

(71) Applicant: HI-STEN, CO., LTD., Gimhae-si, Gyeongsangnam-do (KR)

(72) Inventor: Jong-jae KIM, Gyeongsangnam-do (KR)

(21) Appl. No.: 15/529,719

(22) PCT Filed: Dec. 9, 2014
(86) PCT No.: PCT/KR2014/012077

§ 371 Date: May 25, 2017

(51) Int. Cl. F16J 15/06

(52) U.S. Cl. CPC F16J 15/068

(57) ABSTRACT

The present invention relates to a packing member for water-sealing a pipe, and more particularly, to a packing member inserted into a housing and externally inserted onto an outer side surface of a pipe, the packing member including: an inner circumferential part (261) externally inserted onto the pipe; an outer circumferential part (262) inserted into the housing, one side thereof being connected to the inner circumferential part (261) to form a fluid accommodation part (265) between the inner and outer circumferential parts (261) and (262); and the fluid accommodation part (265) to accommodate a fluid flowing in the pipe, in which the inner circumferential part (261) is brought into close contact with the outer side surface of the pipe by pressure of the accommodated fluid, thereby forming a water-sealing structure with the pipe. According to the present invention, the packing member includes a support part, and thus may maintain a shape of a packing even when exposed to high-pressure fluid environments when connected to the pipe or after installation, thereby providing a highly efficient water-sealing structure.

### TECHNICAL FIELD

The present invention relates to a packing member for connecting pipes, and more particularly, to a packing member for water-sealing a pipe which provides an enhanced water-sealing structure when connected to a pipe.

### BACKGROUND ART

Recently, there has been growing interest in water quality of public water supplies, and, as such water quality problems become important, the use of stainless steel water pipes, which are most suitable for water quality, is attracting much attention.

Water pipes which are buried in the ground and supply tap water require corrosion resistance to protect water quality, water sealing of connection parts, prevention of separation by water pressure, convenience of construction, structural stability sufficient to withstand external environmental changes, and the like. Stainless steel pipes are known to have material properties that are most suitable for such requirements of water pipes. In the case of a stainless steel pipe having a small diameter of 13 A (0.8 T) to 50 A (1.2 T), a method wherein a rubber ring is placed in a socket having an enlarged pipe end and a pipe is inserted there into, followed by joining together by pressing with mechanical force, i.e., a press-type pipe joint, may be used. In the case of a stainless steel pipe having a diameter of 80 A or more (2.0 T or more), it is impossible to perform field work using such press joining, and thus pipe connection has to be performed through welding operation. In this regard, it is very difficult to connect pipes having a diameter of 80 A or more by welding, which requires a skilled welding technician and causes delayed working processes, at the work site.

Flanges may be used in such connection of pipes. A flange may be configured so as to accommodate and fix end portions of two water pipes to be connected. The flange is fixed to form a continuous flow path between the two water pipes so that a fluid can flow continuously. In this case, the flange has to form a water-sealing structure that seals a connection part between the water pipes.

To form a rigid water-sealing structure, a packing and a water pipe must be strongly adhered to each other, and there should be no gap therebetween.

In addition, the packing may be rolled by friction with the water pipe while the water pipe is inserted into the packing. In this case, the packing may not maintain its normal shape and may be folded or turned over on an outer circumferential surface of the water pipe.

### DISCLOSURE

### Technical Problem

Therefore, the present invention has been made in view of the above problems, and it is one object of the present invention to provide a packing member capable of maintaining a shape thereof by minimizing a rolling phenomenon occurring due to friction with a pipe during construction.

The above and other objects can be accomplished by the present invention described below.

### Technical Solution

In accordance with one aspect of the present invention, provided is a packing member for water-sealing a pipe, including: an inner circumferential part 261 externally inserted onto the pipe; an outer circumferential part 262 inserted into the housing, one side thereof being connected to the inner circumferential part 261 to form a fluid accommodation part 265 between the inner and outer circumferential parts 261 and 262; and the fluid accommodation part 265 to accommodate a fluid flowing in the pipe, wherein the inner circumferential part 261 is brought into close contact with the outer side surface of the pipe by pressure of the accommodated fluid, thereby forming a water-sealing structure with the pipe.

In this case, the outer circumferential part 262 is provided with a first flow path groove 266b, the inner circumferential part 261 is provided with a second flow path groove 266a, and, when the pipe is inserted into the inner circumferential part 261, the first and second flow path grooves 266b and 266a are brought into contact with each other to form a flow path connected to the fluid accommodation part 265 to allow a fluid to flow therebetween.

In addition, the packing member for water-sealing a pipe, which is one embodiment of the present invention, includes: the inner circumferential part 261 provided with a plurality of inner circumferential protrusions 261a to increase friction against the outer side surface of the pipe; or the outer circumferential part 262 provided with a plurality of outer circumferential protrusions 262a to increase friction against an inner side surface of the housing 200.

In addition, the packing member for water-sealing a pipe, which is one embodiment of the present invention, further includes a support part 263 provided on a side opposite a side in which an opening of the fluid accommodation part 265 is formed and having an end portion 2631 spaced apart from the pipe by a certain distance while the pipe is inserted.

In another embodiment of the present invention, the packing member for water-sealing a pipe further includes a central separation part 267 positioned between the inner circumferential part 261 and the outer circumferential part 262 and separating the fluid accommodation part 265 into two spaces.

In addition, the packing member for water-sealing a pipe, which is another embodiment of the present invention, is characterized in that the outer circumferential part 262 is provided with a first flow path groove 266b, or the inner circumferential part 261 is provided with a second flow path groove 266a, and the central separation part 267 is provided with a third flow path groove 266c, and, when the pipe is inserted into the inner circumferential part 261, the first and third flow path grooves 266b and 266c are brought into contact with each other, or the second and third flow path grooves 266a and 266c are brought into contact with each other, thereby forming a flow path connected to the fluid accommodation part 265 to allow a fluid to flow therebetween.

### Advantageous Effects

As is apparent from the fore-going description, the present invention advantageously provides a packing member that includes a support part and thus maintains a shape of a packing even when exposed to high-pressure fluid environments when connected to a pipe or after installation, thereby providing a highly efficient water-sealing structure.

In addition, the packing member according to the present invention may be installed without a separate tool while maintaining the shape of a packing, and thus it is easy to construct the packing member at a work site, construction speed is very fast compared to an existing packing member, and construction quality thereof is also excellent.

### DESCRIPTION OF DRAWINGS

The above and other objects, features and other advantages of the present invention will be more clearly understood from the following detailed description taken in conjunction with the accompanying drawings, in which:

FIG. 1 is a perspective view illustrating an upper surface of a packing member for water-sealing a pipe, according to an embodiment of the present invention;

FIG. 2 is a perspective view illustrating a lower surface of the packing member for water-sealing a pipe, according to an embodiment of the present invention;

FIG. 3 is a cross-sectional view of the packing member for water-sealing a pipe, according to an embodiment of the present invention;

FIG. 4 is a cross-sectional view of a packing member for water-sealing a pipe, according to another embodiment of the present invention;

FIGS. 5 and 6 are schematic cross-sectional views illustrating a state when the packing member for water-sealing a pipe, according to an embodiment of the present invention, is inserted;

FIG. 7 is a cross-sectional view taken along a central axis of the packing member for water-sealing a pipe, according to an embodiment of the present invention;

FIG. 8 is a view taken along a central axis of a pipe in a state in which the packing member for water-sealing a pipe, according to an embodiment of the present invention, is coupled to the pipe and a housing;

FIG. 9 is a perspective view illustrating an upper surface of the packing member for water-sealing a pipe, according to another embodiment of the present invention;

FIG. 10 is a partial cross-sectional view of the packing member for water-sealing a pipe, according to another embodiment of the present invention;

FIG. 11 is a perspective view illustrating an upper surface of a packing member for water-sealing a pipe, according to still another embodiment of the present invention;

FIG. 12 is a cross-sectional view taken along a central axis of the packing member for water-sealing a pipe, according to another embodiment of the present invention; and

FIG. 13 is a partial view of the packing member for water-sealing a pipe, according to an embodiment of the present invention, and a housing.

[Description of reference numerals]

| | |
|---|---|
| First packing 260 | Fluid accommodation part 265 |
| Flow path groove 266 | First flow path groove 266b |
| Second flow path groove 266a | Inner circumferential part 261 |
| Outer circumferential part 262 | Support part 263 |
| End portion 2631 | Interface 2632 |

### Mode

Hereinafter, exemplary embodiments of the present invention will be described with reference to the accompanying drawings in such a way that the present invention may be easily carried out by one of ordinary skill in the art to which the present invention pertains.

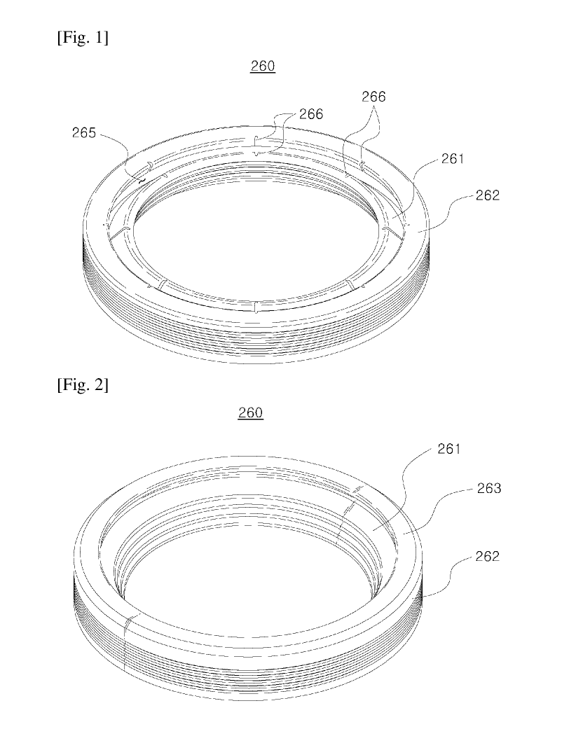

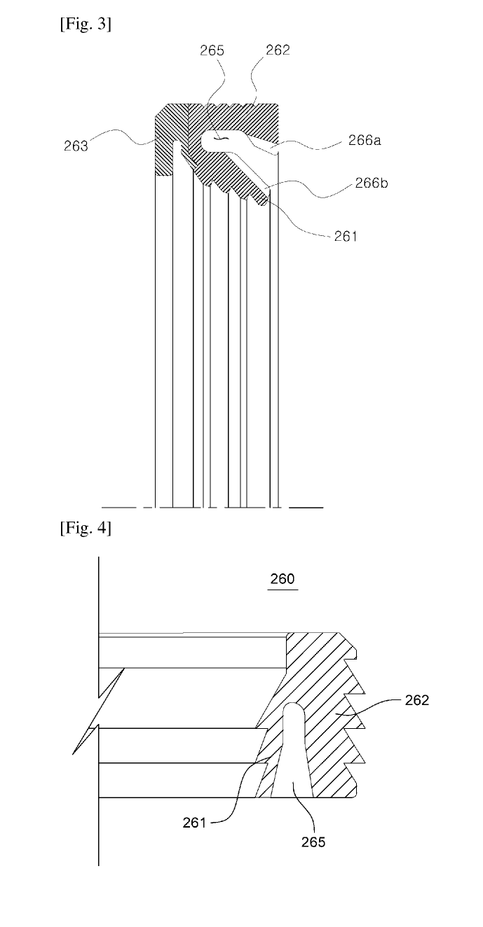

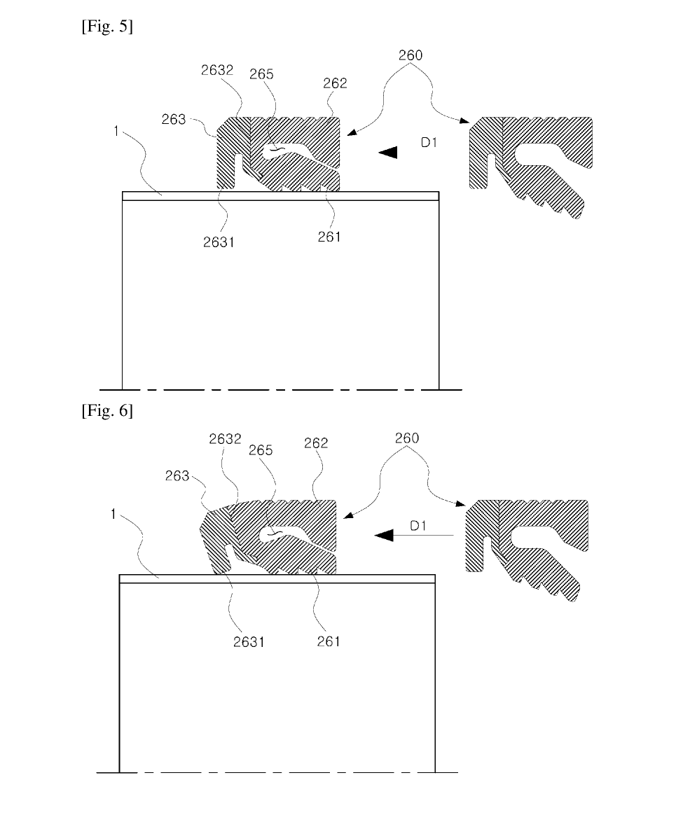

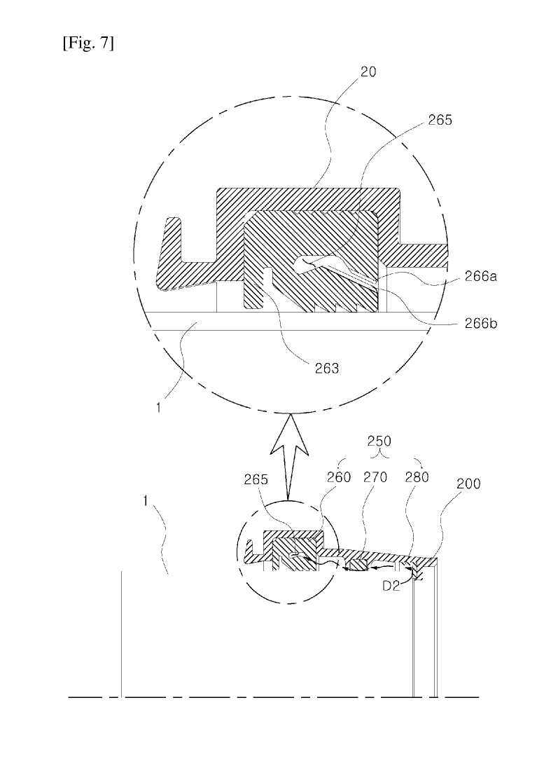

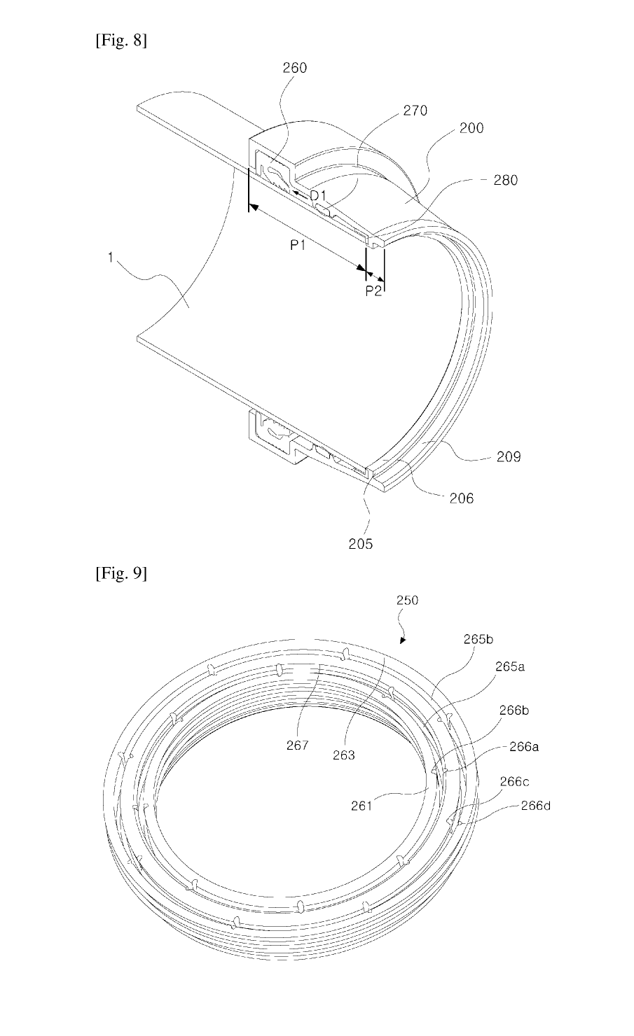

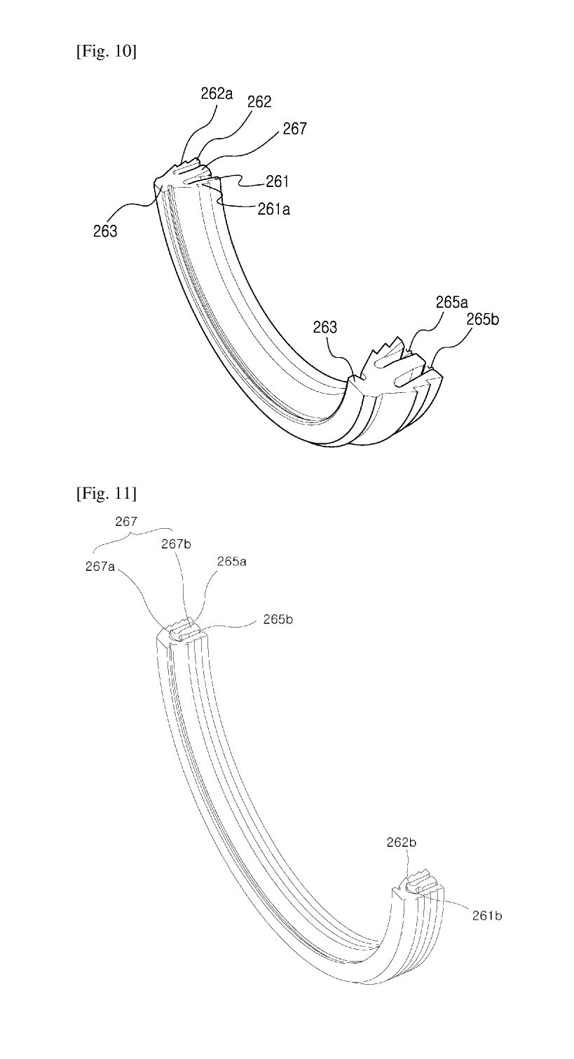

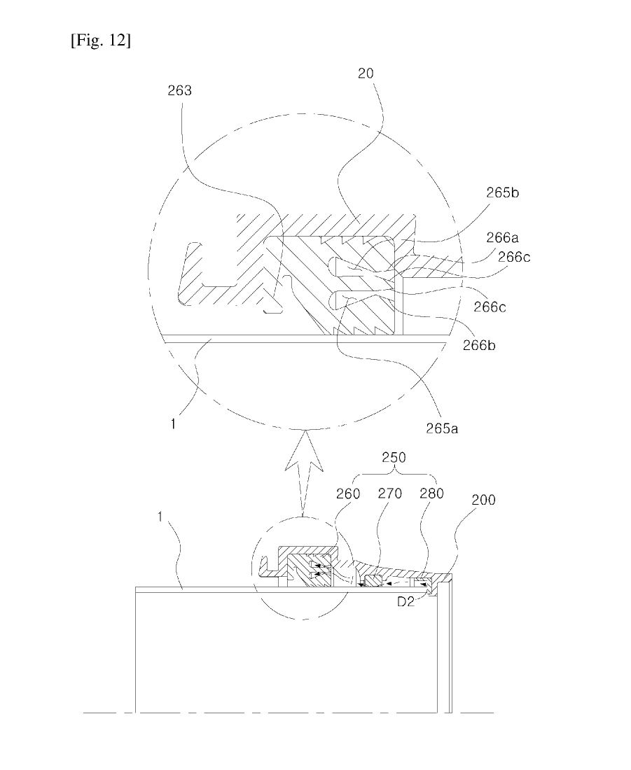

FIG. 1 is a perspective view illustrating an upper surface of a packing member for water-sealing a pipe, according to an embodiment of the present invention. FIG. 2 is a perspective view illustrating a lower surface of the packing member for water-sealing a pipe, according to an embodiment of the present invention. FIG. 3 is a cross-sectional view of the packing member for water-sealing a pipe, according to an embodiment of the present invention. FIG. 4 is a cross-sectional view of a packing member for water-sealing a pipe, according to another embodiment of the present invention. FIGS. 5 and 6 are schematic cross-sectional views illustrating a state when the packing member for water-sealing a pipe, according to an embodiment of the present invention, is inserted. FIG. 7 is a cross-sectional view taken along a central axis of the packing member for water-sealing a pipe, according to an embodiment of the present invention. FIG. 8 is a view taken along a central axis of a pipe in a state in which the packing member for water-sealing a pipe, according to an embodiment of the present invention, is coupled to the pipe and a housing. FIG. 9 is a perspective view illustrating an upper surface of the packing member for water-sealing a pipe, according to another embodiment of the present invention. FIG. 10 is a partial cross-sectional view of the packing member for water-sealing a pipe, according to another embodiment of the present invention. FIG. 11 is a cross-sectional view of a packing member for water-sealing a pipe, according to still another embodiment of the present invention. FIG. 12 is a partial view of the packing member for water-sealing a pipe, according to an embodiment of the present invention, and a housing.

Referring to FIG. 1, the packing member for water-sealing a pipe, according to an embodiment of the present invention, is characterized in that a packing member inserted into a housing and externally inserted onto an outer side surface of a pipe includes: an inner circumferential part 261 externally inserted onto the pipe; an outer circumferential part 262 inserted into the housing, one side thereof being connected to the inner circumferential part 261 to form a fluid accommodation part 265 between the inner and outer circumferential parts 261 and 262; and the fluid accommodation part 265 to accommodate a fluid flowing in the pipe, in which the inner circumferential part 261 is brought into close contact with the outer side surface of the pipe by pressure of the accommodated fluid, thereby forming a water-sealing structure with the pipe.

A packing 260 is a constituent part to form a water-sealing structure of a housing (e.g., a flange or the like) inserted into an inner side surface. The packing 260 may be provided with the fluid accommodation part 265 on an inner side thereof to partially accommodate a fluid between two pipes to be connected.

The pipes may include all pipes with hollow holes to accommodate and transfer a fluid therein, in addition to water pipes.

Referring to FIG. 1, the packing 260 is formed in an overall annular shape. The packing 260 includes the inner circumferential part 261 to form an inner circumferential surface and the outer circumferential part 262 to form an outer circumferential surface. Each of the inner and outer circumferential parts 261 and 262 has an annular shape, and one side of the inner circumferential part 261 is connected to one side of the outer circumferential part 262 to form the fluid accommodation part 265, which is a certain space therebetween.

Referring to FIG. 5, when the housing 200, e.g., a flange, and the pipe 1 are connected to each other, the pipe 1 is inserted into the packing 260. In this case, the inner circumferential part 261 is bent towards the outer circumferential part 262 so that end portions of the inner and outer circumferential parts 261 and 262 contact each other. However, the fluid accommodation part 265 inside of the packing 260 may be maintained as a certain space.

The fluid accommodation part 265 may be filled with a hygroscopic expansion part formed of a hygroscopic material. When the hygroscopic expansion part absorbs a fluid, the volume thereof increases more than in a case in which the fluid accommodation part 265 accommodates only a fluid, thereby further enhancing the performance of a water-sealing structure.

Each of the inner and outer circumferential parts 261 and 262 is provided with flow path grooves 266 at an end portion thereof. The flow path grooves 266 have a groove shape formed from the end portion of each of the inner and outer circumferential parts 261 and 262 to the fluid accommodation part 265.

In this case, the flow path grooves 266 formed in the inner and outer circumferential parts 261 and 262 may be formed at opposite positions. That is, in a case in which the end portions of the inner and outer circumferential parts 261 and 262 contact each other, the flow path grooves 266 formed in the inner circumferential part 261 may contact the flow path grooves 266 formed in the outer circumferential part 262 to form a single flow path. The flow path grooves 266 may be formed in one or more pairs corresponding to each other along the end portions of the inner and outer circumferential parts 261 and 262.

An independent flow path may also be formed at each of the inner and outer circumferential parts 261 and 262.

The packing member for water-sealing a pipe, according to an embodiment of the present invention, is characterized in that the outer circumferential part 262 is provided with a first flow path groove 266b, the inner circumferential part 261 is provided with a second flow path groove 266a, and, when the pipe is inserted into the inner circumferential part 261, the first and second flow path grooves 266b and 266a are brought into contact with each other to form a flow path connected to the fluid accommodation part 265 to allow a fluid to flow therebetween.

As illustrated in FIG. 3, the fluid accommodation part 265 is formed between the inner and outer circumferential parts 261 and 262, and the first and second flow path grooves 266b and 266a are formed from the respective end portions of the inner and outer circumferential parts 261 and 262 to the fluid accommodation part 265.

The first and second flow path grooves 266b and 266a form a single flow path when the inner and outer circumferential parts 261 and 262 are brought into contact with each other so that a fluid can be introduced into the fluid accommodation part 265 from the outside.

Meanwhile, in the above-described embodiment of the present invention, a cross-section of the fluid accommodation part 265, which is a certain space formed between the inner and outer circumferential parts 261 and 262, may have a shape bent at a certain angle as illustrated in FIG. 3, but the shape thereof is not particularly limited so long as it can allow a fluid to flow into the fluid accommodation part 265 and be accommodated therein. For example, the cross-section of the fluid accommodation part 265 may be formed such that the diameter thereof on the side through which a fluid is introduced is large and gradually decreases towards the inside thereof. Additionally, as illustrated in FIG. 4, the cross-section of the fluid accommodation part 265 may be formed such that the diameter thereof decreases towards the inside thereof and is maintained constant in a certain region, which is more preferable in that a fluid can be easily introduced.

The packing member for water-sealing a pipe, which is one embodiment of the present invention, may include: the inner circumferential part 261 provided with a plurality of inner circumferential protrusions 261a to increase friction against the outer side surface of the pipe; or the outer circumferential part 262 provided with a plurality of outer circumferential protrusions 262a to increase friction against an inner side surface of the housing 200.

The inner circumferential part 261 is provided with the inner circumferential protrusions 261a to increase friction against the outer side surface of the pipe.

As illustrated in FIG. 5, the inner circumferential protrusions 261a may be inclined in an externally inserted direction when the inner circumferential part 261 is externally inserted along the outer side surface of the pipe in a direction D1 so as to facilitate the external insertion of the inner circumferential part 261.

When external insertion of the inner circumferential part 261 is completed, the inner circumferential part 261 may pressurize the outer side surface of the pipe after a fluid is accommodated in the fluid accommodation part 265, thereby preventing the pipe from escaping therefrom. That is, the inner circumferential protrusions 261a having a saw blade shape as illustrated in FIG. 5 are pressed until an end portion 2631 of the support part 263 is brought into contact with the outer side surface of the pipe, thereby pressurizing the outer side surface of the pipe.

Through such configuration, the packing member for water-sealing a pipe, which is one embodiment of the present invention, facilitates insertion of a pipe and achieves an effect of preventing the pipe from escaping from the packing 260 to a maximum extent during pressurization through a fluid after insertion of the pipe is completed.

In addition, the outer circumferential part 262 is provided with the outer circumferential protrusions 262a to increase friction against the inner side surface of the housing 200.

The outer circumferential protrusions 262a may be formed as protruding projections as illustrated in FIG. 5, or may have a saw blade shape as illustrated in FIG. 10.

The outer circumferential protrusions 262a are pressed such that the packing 260 is inserted into the housing 200, and the inner side surface of the housing 200 is pressurized by pressure of a fluid accommodated in the fluid accommodation part 265. Through such configuration, binding strength between the housing 200 and the packing 260 may be increased, thereby preventing the housing 200 from rotating along the outer circumferential part 262 of the packing 260.

The packing member for water-sealing a pipe, which is one embodiment of the present invention, may further include the support part 263 for forming an opening toward the pipe to be inserted.

That is, the packing member for water-sealing a pipe, which is one embodiment of the present invention, may further include the support part 263 having the other side in which the fluid accommodation part 265 is opened and the end portion 2631 spaced apart from the pipe by a certain distance while the pipe is inserted.

Referring to FIGS. 2 and 3, the support part 263 protrudes from the side opposite to the side in which the fluid accommodation part 265, which is a lower surface of the packing 260, is opened, and thus, in a case in which the inner circumferential part 261 is wound by friction against the pipe, the support part 263 prevents the inner circumferential part 261 from being wound by being brought into contact with the outer circumferential surface of the pipe.

In one embodiment, the support part 263 according to the present invention may be formed in a letter “” shape such that the support part 263 protrudes from the lower surface of the packing 260 along a central axis of the packing 260 and is provided with the end portion 2631 protruding towards the inserted pipe.

In a case in which there is no friction between a pipe 1 and the packing 260, as illustrated in FIG. 5, the packing 260 may be installed while maintaining a normal shape. However, the packing 260 and the pipe 1 have to closely contact each other to form a rigid water-sealing structure, and the pipe 1 has to be pressurized by the packing 260. Accordingly, very strong friction occurs between the packing 260 and the pipe 1, and thus, when the pipe 1 is inserted into the packing 260, as illustrated in FIG. 6, the packing 260 may be folded or wound.

In other words, when the pipe 1 is installed, the inner circumferential part 261 receives force due to friction against the pipe 1 in a direction opposite to the direction D1 in which the packing 260 proceeds, i.e., a direction in which the pipe 1 is inserted. While the outer circumferential part 262 receives external force so as to proceed in the direction D1, the inner circumferential part 261 receives force in a direction opposite to the direction D1 due to the friction with the pipe 1, and, accordingly, the packing 260 continuously receives a counterclockwise rotational force as viewed in a cross-sectional view.

Due to such installation circumstances, the packing 260 is unable to maintain a normal shape due to winding, partial folding, or the like, resulting in installation in a deformed shape. Such deformation may occur even when the pressure of an internally flowing fluid increases after connection between a pipe and a flange.

In the present invention, the above-described problems may be addressed such that, when the inner circumferential part 261 is externally inserted along the outer side surface of the pipe 1, even when the pressure of a fluid inside the pipe 1 increases after connection between the pipe 1 and a flange, the end portion of the support part 263 is spaced apart from the pipe 1 so as to form a certain distance therebetween.

That is, an interface between the support part 263 and the inner circumferential part 261 or the outer circumferential part 262 may be in a state of being firmly connected by a method such as double injection molding or the like.

As described above, to prevent deformation of the packing 260 when the packing 260 is connected to the pipe 1, the end portion 2631 of the support part 263 is brought into contact with the pipe 1. In a state in which the end portion 2631 of the support part 263 contacts the pipe 1, the packing 260 resists a counterclockwise winding force. Consequently, within the hardness limit of the support part 263, an effect of preventing the packing 260 from being wound counterclockwise may be obtained.

In addition, in the present invention, the support part 263 may be formed of a material that is different from that constituting the inner and outer circumferential parts 261 and 262. In particular, the support part 263 may be formed of a material with a greater hardness than that of the material constituting the inner and outer circumferential parts 261 and 262. Such a double material structure may be realized by a method such as double injection molding or the like.

That is, when the support part 263 is formed of a material having a greater hardness than that of the material constituting the inner and outer circumferential parts 261 and 262, the support part 263 has a stronger force against deformation and thus performs a support function so that the packing 260 can maintain a normal shape.

Hereinafter, a process in which the packing 260 forms a water-sealing structure with a pipe while a fluid is accommodated in the fluid accommodation part 265 will be described with reference to FIGS. 7 and 8.

In a case in which the pressure of a fluid in the pipe 1 increases, the fluid is discharged in an external direction D2 of the pipe 1 via an end portion of the pipe 1, and then, while flowing between the outer circumferential surface of the pipe 1 and the inner circumferential surface of a flange, the fluid consecutively passes through other packings 280 and 270 positioned adjacent to each other as illustrated in FIG. 7, which then reaches the packing 260.

Next, the fluid may be introduced into the fluid accommodation part 265 via a flow path formed as a result of direct contact between the first and second flow path grooves 266b and 266a.

As such, the packings 280 and 270 consecutively form a water-sealing structure, and, when a relatively high pressure occurs as in a case in which the pressure of a fluid instantaneously increases, the water-sealing structure may be maintained by the packing 260.

As described above, the deformation of the packing 260 may occur even under high fluid pressure conditions. Even in this case, deformation of the packing 260 may be prevented by the support part 263.

A packing member for water-sealing a pipe, according to another embodiment of the present invention, may further include a central separation part 267 that is positioned between the inner circumferential part 261 and the outer circumferential part 262 and separates the fluid accommodation part 265 into two spaces.

As illustrated in FIGS. 9 and 10, the central separation part 267 of the packing member for water-sealing a pipe, which is one embodiment of the present invention, has one side connected to one inner side of the inner or outer circumferential part 261 or 262 and separates the fluid accommodation part 265 into two spaces, i.e., a first fluid accommodation part 265a and a second fluid accommodation part 265b.

The central separation part 267 is positioned between the inner and outer circumferential parts 261 and 262 and separates the fluid accommodation part 265 into two spaces, and thus may be formed in an annular shape.

As illustrated in FIG. 5, in a case in which a flange and the pipe 1 are connected to each other, the inner circumferential part 261 is folded in a direction in which the outer circumferential part 262 is disposed and, accordingly, the end portions of the inner and outer circumferential parts 261 and 262 are brought into contact with each other. Similarly, the central separation part 267 is brought into contact with the inner or outer circumferential part 261 or 262, while the first fluid accommodation part 265a or the second fluid accommodation part 265b may maintain a certain space.

Similarly, as described above, the first and second fluid accommodation parts 265a and 265b may be filled with a hygroscopic expansion part formed of a hygroscopic material.

The packing member for water-sealing a pipe, which is another embodiment of the present invention, is characterized in that the outer circumferential part 262 is provided with the first flow path groove 266b, or the inner circumferential part 261 is provided with the second flow path groove 266a, and the central separation part 267 is provided with a third flow path groove 266c, and, when the pipe is inserted into the inner circumferential part 261, the first and third flow path grooves 266b and 266c are brought into contact with each other, or the second and third flow path grooves 266a and 266c are brought into contact with each other, thereby forming a flow path connected to the fluid accommodation part 265 to allow a fluid to flow therebetween.

Flow path grooves 266 formed in the central separation part 267 may be in a groove shape formed from an end portion thereof to the first or second fluid accommodation part 265a or 265b.

In this case, the flow path grooves 266 formed in the central separation part 267 may be formed at a position opposite the flow path grooves 266 formed in the end portion of the inner or outer circumferential part 261 or 262.

This is because, when the central separation part 267 is brought into contact with the end portion of the inner circumferential part 261, the flow path grooves 266 formed in the central separation part 267 and the flow path grooves 266 formed in the inner circumferential part 261 may contact each other to thereby form a single flow path.

In another embodiment, when the central separation part 267 is brought into contact with the end portion of the outer circumferential part 262, the flow path grooves 266 formed in the central separation part 267 and the flow path grooves 266 formed in the outer circumferential part 262 may contact each other to thereby form a single flow path.

These flow path grooves 266 correspond to each other and may be formed in one or more pairs around end portions of the central separation part 267 and the inner circumferential part 261, or around end portions of the central separation part 267 and the outer circumferential part 262.

Hereinafter, the present invention will be described in more detail with reference to FIGS. 9 and 10.

As illustrated in the drawings, the first fluid accommodation part 265a is disposed between the central separation part 267 and the inner circumferential part 261, and the third and first flow path grooves 266c and 266b are respectively formed from the respective end portions of the central separation part 267 and the inner circumferential part 261 to the first fluid accommodation part 265a.

The third and first flow path grooves 266c and 266b form a single flow path when the central separation part 267 and the inner circumferential part 261 are brought into contact with each other so that a fluid can be introduced into the first fluid accommodation part 265a from the outside.

In addition, the second fluid accommodation part 265b is disposed between the central separation part 267 and the outer circumferential part 262, and the third and second flow path grooves 266c and 266a are respectively formed from the respective end portions of the central separation part 267 and the outer circumferential part 262 to the second fluid accommodation part 265b.

The third and second flow path grooves 266c and 266a form a single flow path when the central separation part 267 and the outer circumferential part 262 are brought into contact with each other so that a fluid can be introduced into the second fluid accommodation part 265b from the outside.

As illustrated in FIG. 11, in a packing member for water-sealing a pipe, according to still another embodiment of the present invention, the central separation part 267 is inserted into the fluid accommodation part 265, thereby being divided into two spaces, i.e., the first and second fluid accommodation parts 265a and 265b. In this case, the central separation part 267 may be separated from the fluid accommodation part 265.

The central separation part 267 includes an insertion part 267a and a separation part 267b.

The insertion part 267a is inserted into an inner side surface of the fluid accommodation part 265 and is fixed to a step 261b formed at an inner side surface of the inner circumferential part 261 and a step 262b formed at the outer circumferential part 262.

The separation part 267b is fixedly connected to the insertion part 267a and separates the fluid accommodation part 265 into two spaces, i.e., the first and second fluid accommodation parts 265a and 265b.

Hereinafter, a process in which the packing 260 forms a water-sealing structure with a pipe while a fluid is accommodated in the first and second fluid accommodation parts 265a and 265b will be described with reference to FIG. 12. FIG. 12 is a cross-sectional view taken along a central axis of a packing member for water-sealing a pipe, which is another embodiment. The cross-sectional view is illustrated considering that both the first and second fluid accommodation parts 265a and 265b are present on the central axis.

In a case in which the pressure of a fluid in the pipe 1 increases, the fluid is discharged in the external direction D2 of the pipe 1 via an end portion of the pipe 1, and then, while flowing between the outer circumferential surface of the pipe 1 and the inner circumferential surface of a flange, the fluid consecutively passes through the packings 280 and 270 positioned adjacent to each other as illustrated in FIG. 7, which then reaches the packing 260.

Next, the fluid may be introduced into the first fluid accommodation part 265a via a single flow path formed by the third and first flow path grooves 266c and 266b when the central separation part 267 and the inner circumferential part 261 are brought into contact with each other, and the fluid may be introduced into the second fluid accommodation part 265b via a single flow path formed by the third and second flow path grooves 266c and 266a when the central separation part 267 and the outer circumferential part 262 are brought into contact with each other.

As such, the packings 280 and 270 consecutively form a water-sealing structure, and, when a relatively high pressure occurs as in a case in which the pressure of a fluid instantaneously increases, the water-sealing structure may be maintained by the packing 260.

Hereinafter, a use of the packing member for water-sealing a pipe, according to one embodiment of the present invention, will be described.

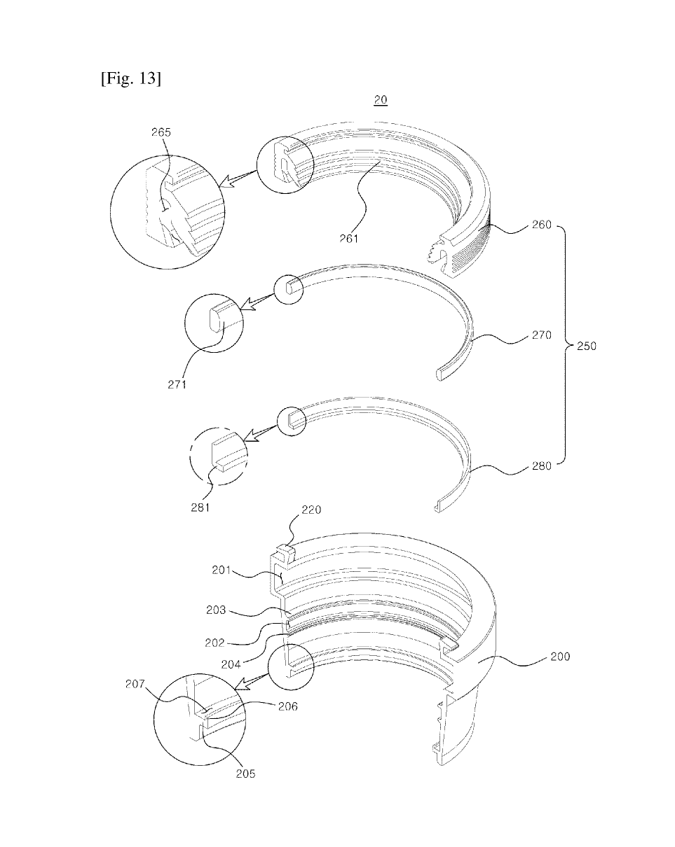

The housing 200 may be formed in a hollow pipe shape as illustrated in FIG. 13. The housing 200 is provided, at an inner circumferential surface thereof, with a packing accommodation part 201 and an insertion restricting part 205 that are disposed in this order when viewed from an upper side of FIG. 13.

The packing accommodation part 201 is a certain spatial part formed by protruding from the inner circumferential surface of the housing 200 to the outside. The packing accommodation part 201 accommodates the packing 260 to be fixed on the inner circumferential surface of the housing 200.

The insertion restricting part 205 is a constituent part that restricts an insertion depth of a pipe inserted into the packing accommodation part 201. The insertion restricting part 205 is formed around the inner circumferential surface of the housing 200 and is formed in an inwardly protruding shape. Meanwhile, the insertion restricting part 205 may be further provided, at an inner end portion thereof, with an extension part 206 upwardly protruding along a central axis direction.

In addition, the housing 200 may be provided, at an upper end thereof, which is an end portion thereof on the side into which a pipe is inserted, with a first fixing projection 220 having a hook shape to allow a clamp to be fastened therewith.

In the following description, as illustrated in FIG. 8, a region of the housing 200, in which the pipe 1 is inserted and accommodated, is referred to as a first accommodation part P1. In addition, a region in which another pipe connected to the pipe 1 is accommodated and fixed is referred to as a second accommodation part P2. In this case, the other pipe may be fixed by welding of a welding part 209 provided at an end portion of the second accommodation part P2. The flange may be fixed using existing pipe fastening methods such as a screw fastening method, and the like in addition to the above-described welding method.

While exemplary embodiments of the present invention have been described, the present invention should not be construed as being limited to the embodiments and should be interpreted by the appended claims. In addition, it is obvious to those of ordinary skill in the art that various changes and modifications may be made within the spirit and scope as defined by the following claims.

1. A packing member for water-sealing a pipe, inserted into a housing and externally inserted onto an outer side surface of a pipe, the packing member comprising:
an inner circumferential part (261) externally inserted onto the pipe;
an outer circumferential part (262) inserted into the housing, one side thereof being connected to the inner circumferential part (261) to form a fluid accommodation part (265) between the inner and outer circumferential parts (261) and (262); and
the fluid accommodation part (265) to accommodate a fluid flowing in the pipe,
wherein the inner circumferential part (261) is brought into close contact with the outer side surface of the pipe by pressure of the accommodated fluid, thereby forming a water-sealing structure with the pipe.

2. The packing member according to claim 1, wherein the outer circumferential part 262 is provided with a first flow path groove (266b), the inner circumferential part (261) is provided with a second flow path groove (266a), and, when the pipe is inserted into the inner circumferential part (261), the first and second flow path grooves (266b) and (266a) are brought into contact with each other to form a flow path connected to the fluid accommodation part (265) to allow a fluid to flow therebetween.

3. The packing member according to claim 1, wherein the packing member includes:
the inner circumferential part (261) provided with a plurality of inner circumferential protrusions (261a) to increase friction against the outer side surface of the pipe; or
the outer circumferential part (262) provided with a plurality of outer circumferential protrusions (262a) to increase friction against an inner side surface of the housing (200).

4. The packing member according to claim 1, further comprising a support part (263) having the other side in which the fluid accommodation part (265) is opened and an end portion (2631) spaced apart from the pipe by a certain distance while the pipe is inserted.

5. The packing member according to claim 1, further comprising a central separation part (267) positioned between the inner circumferential part (261) and the outer circumferential part (262) and separating the fluid accommodation part (265) into two spaces.

6. The packing member according to claim 5, wherein the outer circumferential part (262) is provided with a first flow path groove (266b), or the inner circumferential part (261) is provided with a second flow path groove (266a), and the central separation part (267) is provided with a third flow path groove (266c), and, when the pipe is inserted into the inner circumferential part (261), the first and third flow path grooves (266b) and (266c) are brought into contact with each other, or the second and third flow path grooves (266a) and (266c) are brought into contact with each other, thereby forming a flow path connected to the fluid accommodation part (265) to allow a fluid to flow therebetween.

7. The packing member according to claim 5, wherein the central separation part (267) comprises: an insertion part (267a) inserted into an inner side surface of the fluid accommodation part (265); and a separation part (267b) fixedly connected to the insertion part (267a) and separating the fluid accommodation part (265) into two spaces.
